(19) United States
(12) Patent Application Publication
(10) Pub. No.: US 2020/0302397 A1
(43) Pub. Date: Sep. 24, 2020

(54) SCREENING-BASED OPPORTUNITY ENRICHMENT

(71) Applicant: Microsoft Technology Licensing, LLC, Redmond, WA (US)

(72) Inventors: Christian V. Mathiesen, Mountain View, CA (US); Emrecan Dogan, Menlo Park, CA (US); Alp Artar, Palo Alto, CA (US); Mustafa Emre Kazdagli, Palo Alto, CA (US)

(73) Assignee: Microsoft Technology Licensing, LLC, Redmond, WA (US)

(21) Appl. No.: 16/359,757

(22) Filed: Mar. 20, 2019

(51) Int. Cl. G06Q 10/10; G06F 17/28; G06N 20/00

(52) U.S. Cl. CPC G06Q 10/1053; G06N 20/00; G06F 17/2881

(57) ABSTRACT

The disclosed embodiments provide a system for processing data. During operation, the system applies a machine learning model to attributes of an opportunity to generate a set of confidence scores between the opportunity and a set of screening questions. Next, the system selects a subset of the screening questions with confidence scores that exceed a threshold for use with the opportunity. The system then stores the selected subset of the screening questions in association with the opportunity.

### RELATED APPLICATIONS

The subject matter of this application is related to the subject matter in a co-pending non-provisional application by the same inventors as the instant application and filed on the same day as the instant application, entitled “Assessment-Based Qualified Candidate Delivery,” having Ser. No. TO BE ASSIGNED, and filing date TO BE ASSIGNED (Attorney Docket No. LI-902441-US-NP).

The subject matter of this application is also related to the subject matter in a co-pending non-provisional application by the same inventors as the instant application and filed on the same day as the instant application, entitled “Mapping Assessment Results to Levels of Experience,” having Ser. No. TO BE ASSIGNED, and filing date TO BE ASSIGNED (Attorney Docket No. LI-902442-US-NP).

The subject matter of this application is also related to the subject matter in a co-pending non-provisional application by the same inventors as the instant application and filed on the same day as the instant application, entitled “Assessment-Based Opportunity Exploration,” having Ser. No. TO BE ASSIGNED, and filing date TO BE ASSIGNED (Attorney Docket No. LI-902443-US-NP).

### BACKGROUND

### Field

The disclosed embodiments relate to assessment of candidates. More specifically, the disclosed embodiments relate to techniques for performing screening-based opportunity enrichment for candidates.

### Related Art

Online networks commonly include nodes representing individuals and/or organizations, along with links between pairs of nodes that represent different types and/or levels of social familiarity between the entities represented by the nodes. For example, two nodes in an online network may be connected as friends, acquaintances, family members, classmates, and/or professional contacts. Online networks may further be tracked and/or maintained on web-based networking services, such as online networks that allow the individuals and/or organizations to establish and maintain professional connections, list work and community experience, endorse and/or recommend one another, promote products and/or services, and/or search and apply for jobs.

In turn, online networks may facilitate activities related to business, recruiting, networking, professional growth, and/or career development. For example, professionals may use an online network to locate prospects, maintain a professional image, establish and maintain relationships, and/or engage with other individuals and organizations. Similarly, recruiters may use the online network to search for candidates for job opportunities and/or open positions. At the same time, job seekers may use the online network to enhance their professional reputations, conduct job searches, reach out to connections for job opportunities, and apply to job listings. Consequently, use of online networks may be increased by improving the data and features that can be accessed through the online networks.

### BRIEF DESCRIPTION OF THE FIGURES

FIG. 1 shows a schematic of a system in accordance with the disclosed embodiments.

FIG. 2 shows a system for processing data in accordance with the disclosed embodiments.

FIG. 3 shows a flowchart illustrating a process of performing screening-based opportunity enrichment in accordance with the disclosed embodiments.

FIG. 4 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

The disclosed embodiments provide a method, apparatus, and system for using assessments to improve targeting and placement of candidates with opportunities. In these embodiments, assessments include techniques and/or data that are used to determine qualifications of the candidates for the opportunities. For example, an assessment may include a screening question that is presented to a candidate to determine whether the candidate meets a corresponding requirement for a job. In another example, an assessment may include a skill assessment of a candidate, in which the candidate's proficiency in a corresponding skill is determined based on the candidate's answers to a series of questions related to the skill. As a result, assessments can be used to identify highly qualified candidates for the opportunities, thus reducing overhead associated with applying to and/or filling the opportunities.

More specifically, the disclosed embodiments provide a method, apparatus, and system for performing screening-based job enrichment, in which jobs and/or other opportunities are “enriched” using screening questions and/or other types of assessments of qualifications related to the opportunities. Attributes of a job are inputted into a machine learning model, and confidence scores between the attributes and a set of available screening questions are obtained as output from the machine learning model. Each confidence score may be a numeric representation of confidence in the relevance of a corresponding screening question to the job and/or the likelihood that the screening question matches one or more requirements of the job.

One or more thresholds are applied to the confidence scores to identify subsets of the screening questions as relevant or potentially relevant to the job. For example, screening questions with confidence scores that exceed a threshold representing high confidence may automatically be added to and/or associated with the job. In another example, screening questions with confidence scores that fall below the threshold for high confidence but exceed another threshold for minimum confidence may be outputted with the job's description to one or more verifying users, and the verifying user(s) may provide input indicating the relevance or lack of relevance of each screening question to the job.

By identifying and generating screening questions for jobs based on the content of the jobs, the disclosed embodiments allow highly qualified candidates for the jobs to be identified based on the candidates' answers to the screening questions. In contrast, conventional techniques may lack the ability to automatically generate screening questions for jobs. Instead, moderators for the jobs may be required to manually identify qualified candidates for the jobs from a much larger pool of applicants. At the same time, candidates may apply to jobs for which the candidates are not qualified, resulting in a lower response rate to the candidates' job applications and/or slower progress in the candidates' job searches.

Conventional techniques may also, or instead, involve moderators manually inputting screening questions for jobs and/or selecting the screening questions from a catalog of hundreds or thousands of available screening questions. Such manual specification and/or selection of screening questions can be time-consuming and/or result in the use of irrelevant screening questions with the jobs. On the other hand, automatic identification and generation of relevant screening questions for jobs performed by the disclosed embodiments may streamline both the job-posting process and subsequent identification of qualified candidates for the moderators. Consequently, the disclosed embodiments may improve computer systems, applications, user experiences, tools, and/or technologies related to user recommendations, employment, recruiting, and/or hiring.

### Screening-Based Opportunity Enrichment

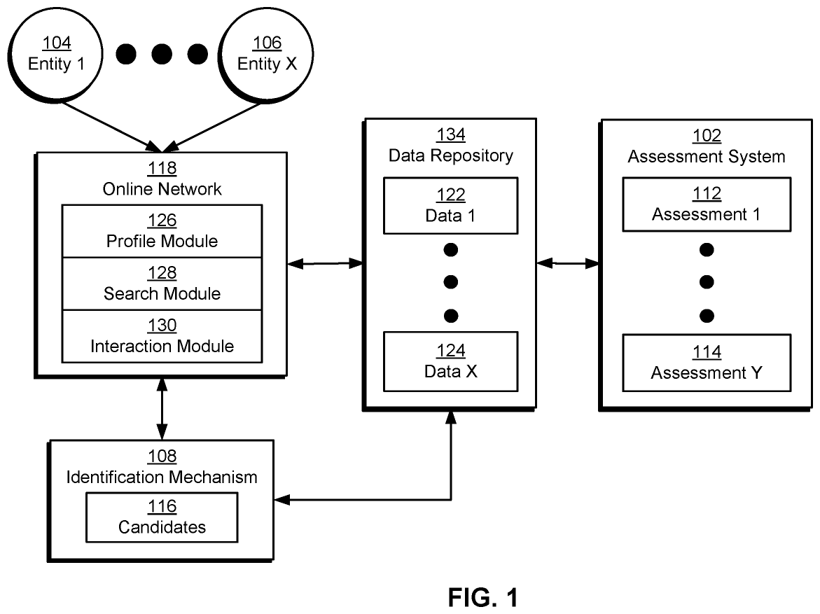

FIG. 1 shows a schematic of a system in accordance with the disclosed embodiments. As shown in FIG. 1, the system may include an online network 118 and/or other user community. For example, online network 118 may include an online professional network that is used by a set of entities (e.g., entity 1 104, entity x 106) to interact with one another in a professional and/or business context.

The entities may include users that use online network 118 to establish and maintain professional connections, list work and community experience, endorse and/or recommend one another, search and apply for jobs, and/or perform other actions. The entities may also include companies, employers, and/or recruiters that use online network 118 to list jobs, search for potential candidates, provide business-related updates to users, advertise, and/or take other action.

Online network 118 includes a profile module 126 that allows the entities to create and edit profiles containing information related to the entities' professional and/or industry backgrounds, experiences, summaries, job titles, projects, skills, and so on. Profile module 126 may also allow the entities to view the profiles of other entities in online network 118.

Profile module 126 may also include mechanisms for assisting the entities with profile completion. For example, profile module 126 may suggest industries, skills, companies, schools, publications, patents, certifications, and/or other types of attributes to the entities as potential additions to the entities' profiles. The suggestions may be based on predictions of missing fields, such as predicting an entity's industry based on other information in the entity's profile. The suggestions may also be used to correct existing fields, such as correcting the spelling of a company name in the profile. The suggestions may further be used to clarify existing attributes, such as changing the entity's title of “manager” to “engineering manager” based on the entity's work experience.

Online network 118 also includes a search module 128 that allows the entities to search online network 118 for people, companies, jobs, and/or other job- or business-related information. For example, the entities may input one or more keywords into a search bar to find profiles, job postings, job candidates, articles, and/or other information that includes and/or otherwise matches the keyword(s). The entities may additionally use an “Advanced Search” feature in online network 118 to search for profiles, jobs, and/or information by categories such as first name, last name, title, company, school, location, interests, relationship, skills, industry, groups, salary, experience level, etc.

Online network 118 further includes an interaction module 130 that allows the entities to interact with one another on online network 118. For example, interaction module 130 may allow an entity to add other entities as connections, follow other entities, send and receive emails or messages with other entities, join groups, and/or interact with (e.g., create, share, re-share, like, and/or comment on) posts from other entities.

Those skilled in the art will appreciate that online network 118 may include other components and/or modules. For example, online network 118 may include a homepage, landing page, and/or content feed that provides the entities the latest posts, articles, and/or updates from the entities' connections and/or groups. Similarly, online network 118 may include features or mechanisms for recommending connections, job postings, articles, and/or groups to the entities.

In one or more embodiments, data (e.g., data 1 122, data x 124) related to the entities' profiles and activities on online network 118 is aggregated into a data repository 134 for subsequent retrieval and use. For example, each profile update, profile view, connection, follow, post, comment, like, share, search, click, message, interaction with a group, address book interaction, response to a recommendation, purchase, and/or other action performed by an entity in online network 118 may be tracked and stored in a database, data warehouse, cloud storage, and/or other data-storage mechanism providing data repository 134.

Data in data repository 134 may then be used to generate recommendations and/or other insights related to listings of jobs or opportunities within online network 118. For example, one or more components of online network 118 may track searches, clicks, views, text input, conversions, and/or other feedback during the entities' interaction with a job search tool in online network 118. The feedback may be stored in data repository 134 and used as training data for one or more machine learning models, and the output of the machine learning model(s) may be used to display and/or otherwise recommend a number of job listings to current or potential job seekers in online network 118.

More specifically, data in data repository 134 and one or more machine learning models are used to produce rankings of candidates associated with jobs or opportunities listed within or outside online network 118. As shown in FIG. 1, an identification mechanism 108 identifies candidates 116 associated with the opportunities. For example, identification mechanism 108 may identify candidates 116 as users who have viewed, searched for, and/or applied to jobs, positions, roles, and/or opportunities, within or outside online network 118. Identification mechanism 108 may also, or instead, identify candidates 116 as users and/or members of online network 118 with skills, work experience, and/or other attributes or qualifications that match the corresponding jobs, positions, roles, and/or opportunities.

After candidates 116 are identified, profile and/or activity data of candidates 116 may be inputted into the machine learning model(s), along with features and/or characteristics of the corresponding opportunities (e.g., required or desired skills, education, experience, industry, title, etc.). In turn, the machine learning model(s) may output scores representing the strength of candidates 116 with respect to the opportunities and/or qualifications related to the opportunities (e.g., skills, current position, previous positions, overall qualifications, etc.). For example, the machine learning model(s) may generate scores based on similarities between the candidates' profile data with online network 118 and descriptions of the opportunities. The model(s) may further adjust the scores based on social and/or other validation of the candidates' profile data (e.g., endorsements of skills, recommendations, accomplishments, awards, patents, publications, reputation scores, etc.). The rankings may then be generated by ordering candidates 116 by descending score.

In turn, rankings based on the scores and/or associated insights may improve the quality of candidates 116, recommendations of opportunities to candidates 116, and/or recommendations of candidates 116 for opportunities. Such rankings may also, or instead, increase user activity with online network 118 and/or guide the decisions of candidates 116 and/or moderators involved in screening for or placing the opportunities (e.g., hiring managers, recruiters, human resources professionals, etc.). For example, one or more components of online network 118 may display and/or otherwise output a member's position (e.g., top 10%, top 20 out of 138, etc.) in a ranking of candidates for a job to encourage the member to apply for jobs in which the member is highly ranked. In a second example, the component(s) may account for a candidate's relative position in rankings for a set of jobs during ordering of the jobs as search results in response to a job search by the candidate. In a third example, the component(s) may recommend highly ranked candidates for a position to recruiters and/or other moderators as potential applicants and/or interview candidates for the position. In a fourth example, the component(s) may recommend jobs to a candidate based on the predicted relevance or attractiveness of the jobs to the candidate and/or the candidate's likelihood of applying to the jobs.

In one or more embodiments, rankings and/or recommendations related to candidates 116 and/or opportunities are generated based on assessments (e.g., assessment 1 112, assessment y 114) of candidates 116 with respect to the opportunities. Such assessments include techniques and/or data for verifying or ascertaining the qualifications of candidates 116 for the opportunities.

In one or more embodiments, assessments include screening questions that are presented to some or all candidates 116 for a given opportunity to determine whether candidates 116 meet requirements for the opportunity. Each screening question may specify a parameter and a condition associated with the parameter. For example, the screening question may ask a candidate to provide the number of years of experience he or she has with a skill (e.g., “How many years of programming experience do you have?”), tool (e.g., “How many years of work experience do you have using Microsoft Office?”), and/or other type of parameter representing a job-related qualification. In another example, a screening question may ask the candidate to provide a yes/no answer related to a language (e.g., “Do you speak Spanish?”), work authorization (e.g., “Are you authorized to work in the United States?”), license or certification (e.g., “Do you have a license or certification in CPR & AED”), location (e.g., “Are you willing to relocate to the SF Bay Area?”), and/or security clearance (e.g., “Do you possess a security clearance with the United States government?”), and/or other type of parameter representing a job-related qualification.

A candidate's answer to a screening question may then be compared with a value, range of values, set of values, and/or threshold associated with the corresponding parameter or qualification to identify one or more jobs for which the candidate is qualified or not qualified. For example, the candidate may be prompted to answer a series of screening questions for a specific job; if the candidate's answers to the screening questions meet the job's requirements, the candidate may be allowed to apply to the job. In another example, the candidate may opt in to a setting and/or preference that stores the candidate's previous answers to screening questions. In turn, the stored answers may be used to match the candidate to additional jobs and/or opportunities for which the candidate is qualified.

In one or more embodiments, assessments include skill assessments of candidates 116. Each skill assessment determines the proficiency of candidates 116 in a given skill based on the candidates' answers to a series of questions related to the skill. The skill assessment may be adaptive, in which the difficulty of a subsequent question is selected and/or adjusted based on the correctness of the candidate's answer's to previous questions in the skill assessment. After the candidate completes the skill assessment, a numeric rating (or score) for the candidate may be calculated based on the correctness of the candidate's answers to questions in the skill assessment and/or the difficulty of the questions. Consequently, screening questions, skill assessments, and/or other types of assessments can be used to identify highly qualified candidates for the opportunities, thus reducing overhead associated with applying to and/or filling the opportunities.

An assessment system 102 provided by and/or accessed through online network 118 interacts with candidates 116 to perform assessments of candidates 116. For example, assessment system 102 may form a part of a recruiting and/or job search product or tool offered by or through online network 118. As a result, assessment system 102 may integrate with other features of online network 118, such as profile module 126, search module 128, and/or interaction module 130. As a candidate browses and/or searches for jobs and/or other opportunities through online network 118, assessment system 102 may present the candidate with screening questions, skill assessments, and/or other types of assessments related to qualifications of the jobs and/or opportunities. Assessment system 102 may also, or instead, include modules or user-interface elements that allow candidates 116 to voluntarily provide answers to screening questions and/or take skill assessments separately from job searches or job browsing conducted by candidates 116.

In one or more embodiments, online network 118 and/or assessment system 102 include functionality to enrich jobs and/or opportunities posted in online network 118 with screening questions and/or other assessments of qualifications for the jobs and/or opportunities. For example, online network 118 and/or assessment system 102 may automatically add screening questions to a job based on the content of the job and/or attributes of the job.

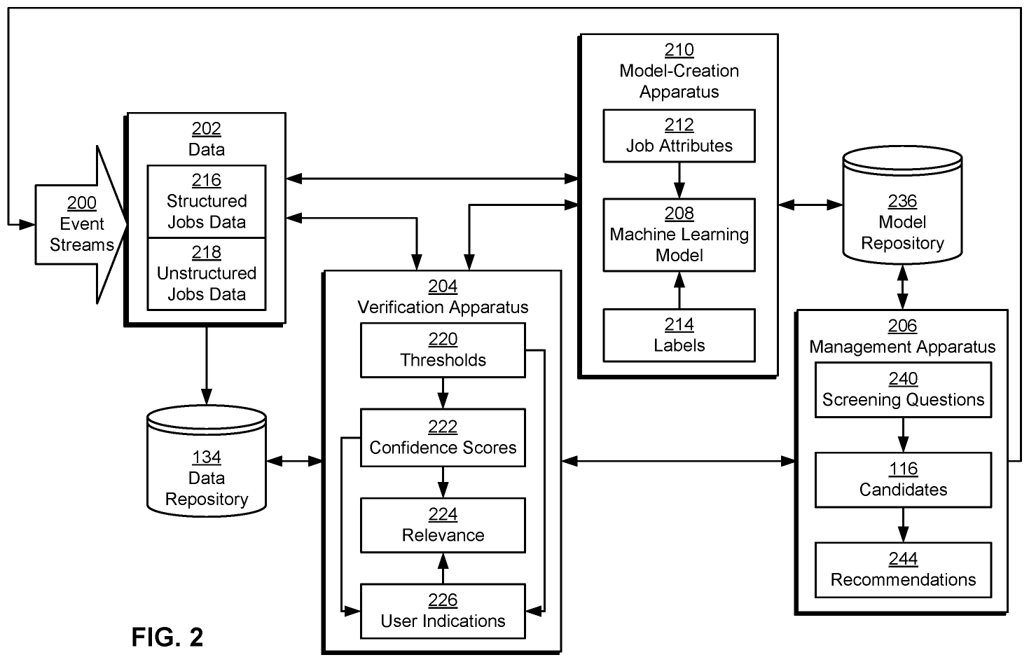

As shown in FIG. 2, data repository 134 and/or another primary data store may be queried for data 202 that includes structured jobs data 216 and unstructured jobs data 218 for jobs that are posted or described within or outside an online network (e.g., online network 118 of FIG. 1). Structured jobs data 216 includes structured representations of job attributes 212 associated with each job, which can be provided by a recruiter, hiring manager, and/or other moderator during posting of the job in the online network.

For example, the moderator may enter job attributes 212 such as the job's function, role, title, industry, seniority, location, industry, required skills, responsibilities, salary range, benefits, education level, and/or screening questions 240 into different text fields within a user interface provided by online network 118. To specify a screening question for the job, the moderator may select a category associated with the screening question, such as work experience, education, location, work authorization, language, visa status, certifications, expertise with tools, and/or security clearances. The moderator may then select from a set of available parameters and/or conditions associated with the category, such as values and/or thresholds representing requirements or qualifications for the job.

Conversely, unstructured jobs data 218 may include unstructured and/or freeform text that lacks user-specified job attributes 212.

For example, online network 118 may include functionality to “import” jobs through distribution partnerships, application-programming interfaces (APIs), scraping, data feeds, and/or other data sources. As a result, such jobs may lack user-specified screening questions 240 that can be used to filter and/or sort candidates 116 based on qualifications for the jobs.

In one or more embodiments, data repository 134 stores data 202 that represents standardized, organized, and/or classified attributes. For example, skills in structured jobs data 216 and/or unstructured jobs data 218 may be organized into a hierarchical taxonomy that is stored in data repository 134. The taxonomy may model relationships between skills and/or sets of related skills (e.g., “Java programming” is related to or a subset of “software engineering”) and/or standardize identical or highly related skills (e.g., “Java programming,” “Java development,” “Android development,” and “Java programming language” are standardized to “Java”). In another example, locations in data repository 134 may include cities, metropolitan areas, states, countries, continents, and/or other standardized geographical regions. In a third example, data repository 134 includes standardized company names for a set of known and/or verified companies associated with the members and/or jobs. In a fourth example, data repository 134 includes standardized titles, seniorities, and/or industries for various jobs, members, and/or companies in the online network. In a fifth example, data repository 134 includes standardized time periods (e.g., daily, weekly, monthly, quarterly, yearly, etc.) that can be used to retrieve profile data 216, jobs data 218, and/or other data 202 that is represented by the time periods (e.g., starting a job in a given month or year, graduating from university within a five-year span, job listings posted within a two-week period, etc.). In a sixth example, data repository 134 includes standardized job functions such as “accounting,” “consulting,” “education,” “engineering,” “finance,” “healthcare services,” “information technology,” “legal,” “operations,” “real estate,” “research,” and/or “sales.”

Data 202 in data repository 134 may further be updated using records of recent activity received over one or more event streams 200. For example, event streams 200 may be generated and/or maintained using a distributed streaming platform such as Apache Kafka (Kafka™ is a registered trademark of the Apache Software Foundation). One or more event streams 200 may also, or instead, be provided by a change data capture (CDC) pipeline that propagates changes to data 202 from a source of truth for data 202. For example, an event containing a record of a recent profile update, job search, job view, job application, response to a job application, connection invitation, post, like, comment, share, and/or other recent member activity within or outside the community may be generated in response to the activity. The record may then be propagated to components subscribing to event streams 200 on a nearline basis.

Management apparatus 206 generates recommendations 244 related to candidates 116 and jobs based on data 202 in data repository 202. For example, management apparatus 206 may generate recommendations 244 as search results of the candidates' job searches, search results of recruiters' candidate searches for specific jobs, job recommendations that are displayed and/or transmitted to the candidates, and/or within other contexts related to job seeking, recruiting, careers, and/or hiring.

To generate recommendations 244, management apparatus 206 retrieves, from a model repository 236, a model-creation apparatus 210, and/or another data source, the latest parameters of one or more machine learning models that generate predictions related to a candidate's compatibility with a job, the likelihood that the candidate has a positive response to (e.g., clicks on, applies to, and/or saves) the job, and/or the candidate's strength or quality with respect to requirements or qualifications of job. Next, management apparatus 206 inputs features, such as encodings and/or embeddings of one or more jobs and/or parameters of a job search query by the candidate, into the machine learning model(s).

Management apparatus 206 uses the model parameters and features to generate a set of scores between the candidate and a set of jobs. For example, management apparatus 206 may apply a logistic regression model, deep learning model, support vector machine, tree-based model, and/or another type of machine learning model to features for a candidate-job pair to produce a score from 0 to 1 that represents the probability that the candidate has a positive response to a job recommendation (e.g., recommendations 244) that is displayed to the candidate.

Management apparatus 206 then generates rankings of the jobs by the corresponding scores. For example, management apparatus 206 may rank jobs for a candidate by descending predicted likelihood of positively responding to the jobs. Finally, management apparatus 206 outputs some or all jobs in the rankings as recommendations 244 to the corresponding candidates 116. For example, management apparatus 206 may display some or all jobs that are ranked by a candidate's descending likelihood of applying to the jobs within a job search tool, email, notification, message, and/or another communication containing job recommendations 244 to the candidate. Subsequent responses to recommendations 244 may, in turn, be used to generate events that are fed back into the system and used to update machine learning models used to generate recommendations 244.

Management apparatus 206 also uses screening questions 240 to generate, filter, and/or update recommendations 244 related to applying to the jobs by candidates 116. For example, management apparatus 206 may display screening questions 240 for one or more recommended jobs within a user interface and obtain answers to the displayed screening questions 240 from a candidate. If the answers meet requirements for the job(s), management apparatus 206 may display user-interface elements that allow the candidate to apply to the job. If the answers do not meet requirements for the job(s), management apparatus 206 may generate and output recommendations 244 of other jobs to the candidate, such as jobs for which the candidate is still potentially qualified based on the candidate's answers. In another example, management apparatus 206 may use the answers to screening questions 240 by candidates 116 to generate recommendations 244 containing lists of highly qualified candidates 116 for one or more jobs. Management apparatus 206 may provide the lists to moderators of the job(s), thus allowing the moderators to reach out to the highly qualified candidates 116 and/or prioritize the candidates' applications over those of less-qualified candidates.

Management apparatus 206 and/or another component may additionally track responses to recommendations 244 and/or applications to jobs associated with screening questions 240. For example, the component may generate records of positive responses such as views of candidate profiles, messages from job moderators to candidates 116, scheduling of interviews for candidates 116, adding candidates to hiring pipelines, and/or hiring of candidates 116 after candidates 116 apply to jobs and/or pass screening questions 240 for the jobs. The component may also, or instead, generate records of negative responses such as rejections of candidates 116 by moderators and/or lack of action on candidates 116 by the moderators after candidates 116 apply to jobs and/or pass screening questions 240 for the jobs.

As mentioned above, the system of FIG. 2 includes functionality to automatically identify screening questions 240 for jobs in data repository 134 based on the content and/or attributes of the jobs. For example, the system may analyze structured jobs data 216 and/or unstructured jobs data 218 that lack user-specified screening questions 240 to identify screening questions 240 that match the requirements or qualifications of the corresponding jobs.

More specifically, model-creation apparatus 210 creates a machine learning model 208 that estimates or predicts the relevance of various screening questions 240 to job attributes 212 associated with jobs in data repository 134. To create machine learning model 208, model-creation apparatus 210 inputs one or more job attributes 212 from structured jobs data 216 into machine learning model 208 and obtains output representing confidence scores 222 between each job and a set of possible screening questions 240. For example, model-creation apparatus 210 may apply machine learning model 208 to a job's title, industry, description, requirements, responsibilities, and/or other attributes from structured jobs data 216 to generate, for each screening question, a confidence score from 0 to 1 that represents the probability that the screening question is relevant to or matches the job.

Next, model-creation apparatus 210 updates parameters of machine learning model 208 based on differences between confidence scores 222 and/or other predictions outputted by machine learning model 208 and labels 214 associated with the predictions. For example, model-creation apparatus 210 may obtain and/or generate positive labels 214 for screening questions 240 that are found in structured jobs data 216 for the corresponding jobs and negative labels 214 for screening questions 240 that are not found in structured jobs data 216 for the corresponding jobs. Model-creation apparatus 210 may also, or instead, obtain and/or generate positive labels 214 for positive outcomes (e.g., views of candidate profiles, messages from moderators to candidates, adding candidates to hiring pipelines, scheduling interviews with candidates, hiring of candidates, etc.) associated with screening questions 240 and/or the corresponding job applications. Similarly, model-creation apparatus 210 may obtain and/or generate negative labels 214 for negative outcomes (e.g., rejecting candidates, ignoring candidates, etc.) associated with screening questions 240 and/or the corresponding job applications. After labels 214 are obtained or produced, model-creation apparatus 210 may use a training technique and/or one or more hyperparameters to update parameter values of machine learning model 208 based on job attributes 212 and the corresponding predictions and labels 214. Model-creation apparatus 210 may then store updated parameter values and/or other data associated with machine learning model 208 in model repository 236 and/or another data store for subsequent retrieval and use.

After machine learning model 208 is created and/or updated by model-creation apparatus 210, management apparatus 206 obtains a representation of machine learning model 208 from model-creation apparatus 210, model repository 236, and/or another source. Next, management apparatus 206 uses machine learning model 208 and job attributes 212 of jobs that lack user-provided screening questions 240 to generate confidence scores 222 between the jobs and a set of available screening questions 240.

In one or more embodiments, job attributes 212 inputted into machine learning model 208 include some or all text in unstructured jobs data 218 and/or some or all user-specified job attributes 212 in structured jobs data 216. For example, job attributes 212 may include words, phrases, sentences, and/or other portions of text in unstructured jobs data 218. In another example, job attributes 212 may include values of titles, functions, locations, skills, industries, seniority levels, types of employment, and/or other fields that are specified by posters and/or moderators of the corresponding jobs.

Job attributes 212 may also, or instead, include mappings of portions of unstructured jobs data 218 to standardized attributes in data repository 134. For example, one or more components of the system may identify job attributes 212 of unstructured jobs data 218 by mapping key words and/or phrases in unstructured jobs data 218 to titles, job functions, seniority levels, industries, skills, types of employment, and/or other types of standardized attributes associated with the jobs. In turn, management apparatus 206 may input some or all job attributes 212 for a given job into machine learning model 208 and obtain confidence scores 222 between the job and a set of potential screening questions 240 as output from machine learning model 208.

Management apparatus 206, a verification apparatus 204, and/or another component use one or more thresholds 220 to identify a subset of screening questions 240 with confidence scores 222 that indicate high relevance 224 to the corresponding jobs. For example, the component may identify screening questions 240 with confidence scores 222 that are 95^{th} percentile or higher. The component additionally stores associations between the identified screening questions 240 and the corresponding jobs in data repository 134 and/or another data source. In turn, the associations may trigger the use of screening questions 240 in validating the qualifications of candidates 116 for the jobs before such candidates 116 are able to apply to the jobs and/or are recommended to moderators of the jobs.

In one or more embodiments, verification apparatus 204 identifies additional screening questions 240 for use with jobs based on user indications 226 and/or other external verification of relevance 224 of the additional screening questions 240. For example, verification apparatus 204 may identify the additional screening questions 240 as having confidence scores 222 that do not meet the threshold for high relevance 224 and/or that are higher than a threshold for minimum relevance 224 to the corresponding jobs.

More specifically, verification apparatus 204 verifies relevance 224 of the additional screening questions 240 to the corresponding jobs. First, verification apparatus 204 outputs the identified screening questions 240 with the corresponding job attributes 212 to one or more verifying users. In response to the outputted screening questions 240 and job attributes 212, the verifying users may provide user indications 226 of relevance 224 between the outputted screening questions 240 and the corresponding job attributes 212. For example, verification apparatus 204 may display the content of a posted job and a potential screening question for the job to a verifying user within a user interface and/or crowdsourcing platform, and the verifying user may specify whether the screening question fits the content of the job through the user interface and/or crowdsourcing platform. The verifying user may also, or instead, specify a change or substitution to the screening question that increases the relevance of the screening question to the job. The verifying user may also, or instead, indicate that no available screening questions 240 can be used with the job.

In some embodiments, verification apparatus 204 prompts verifying users to supply screening questions 240 for one or more jobs, in lieu of or in addition to verifying relevance 224 of screening questions 240 identified by machine learning model 208 for the job(s). For example, verification apparatus 204 may identify a subset of jobs for which confidence scores 222 between the jobs and all screening questions fall below a minimum threshold for relevance 224. Verification apparatus 204 may display the content of each job to a verifying user and prompt the verifying user to select or provide one or more screening questions 240 for the job. Verification apparatus 204 may also provide an option that allows the verifying user to verify a lack of relevant screening questions 240 for the job.

Verification apparatus 204 stores user indications 226 of relevance 224 for pairs of jobs and screening questions 240 in data repository 134 and/or another data store. In turn, management apparatus 206 uses user indications 226 and/or corresponding associations between the jobs and screening questions 240 to perform screening and/or assessment of candidates 116 for the jobs.

Model-creation apparatus 210 additionally uses labels 214 generated from user indications 226 to update machine learning model 208. For example, model-creation apparatus 210 may generate positive labels 214 for screening questions 240 that are identified or verified as relevant to the corresponding jobs. Conversely, model-creation apparatus 210 may generate negative labels 214 for screening questions 240 that are identified or verified as not relevant to the corresponding jobs. Model-creation apparatus 210 may then update parameters of machine learning model 208 so that machine learning model better predicts the positive and negative labels 214 from the corresponding job attributes 212. In turn, management apparatus 206 and/or other components may use the updated machine learning model 208 to identify screening questions 240 for use with additional jobs. As a result, the accuracy or relevance 224 of screening questions 240 identified by the system for jobs in data repository 134 may improve over time.

By identifying and generating screening questions for jobs based on the content of the jobs, the system of FIG. 2 allows highly qualified candidates for the jobs to be identified based on the candidates' answers to the screening questions. In contrast, conventional techniques may lack the ability to automatically generate screening questions for jobs. Instead, moderators for the jobs may be required to manually identify qualified candidates for the jobs from a much larger pool of applicants. At the same time, candidates may apply to jobs for which the candidates are not qualified, resulting in a lower response rate to the candidates' job applications and/or slower progress in the candidates' job searches.

Conventional techniques may also, or instead, involve moderators manually inputting screening questions for jobs and/or selecting the screening questions from a catalog of hundreds or thousands of available screening questions. Such manual specification and/or selection of screening questions can be time-consuming and/or result in the use of irrelevant screening questions with the jobs. On the other hand, automatic identification and generation of relevant screening questions for jobs performed by the system of FIG. 2 may streamline both the job-posting process and subsequent identification of qualified candidates for the moderators. Consequently, the disclosed embodiments may improve computer systems, applications, user experiences, tools, and/or technologies related to user recommendations, employment, recruiting, and/or hiring.

Those skilled in the art will appreciate that the system of FIG. 2 may be implemented in a variety of ways. First, verification apparatus 204, model-creation apparatus 210, management apparatus 206, data repository 134, and/or model repository 236 may be provided by a single physical machine, multiple computer systems, one or more virtual machines, a grid, one or more databases, one or more filesystems, and/or a cloud computing system. Verification apparatus 204, model-creation apparatus 210, and management apparatus 206 may additionally be implemented together and/or separately by one or more hardware and/or software components and/or layers.

Second, a number of models and/or techniques may be used to generate confidence scores 222, recommendations 244, and/or other output used to improve the matching of candidates 116 with jobs. For example, the functionality of machine learning model 208 may be provided by a regression model, artificial neural network, support vector machine, decision tree, naïve Bayes classifier, Bayesian network, clustering technique, collaborative filtering technique, deep learning model, hierarchical model, and/or ensemble model. The retraining or execution of machine learning model 208 may also be performed on an offline, online, and/or on-demand basis to accommodate requirements or limitations associated with the processing, performance, or scalability of the system and/or the availability of job attributes 212 and labels 214 used to train the machine learning model 208. Multiple versions of machine learning model 208 may further be adapted to different subsets of jobs (e.g., jobs associated with different locations, industries, seniorities, etc.), or the same machine learning model may be used to generate confidence scores 222 for all jobs.

Third, the system of FIG. 2 may be adapted to generate and/or identify screening questions 240 for various types of opportunities. For example, the functionality of the system may be used to enrich postings for academic positions, artistic or musical roles, school admissions, fellowships, scholarships, competitions, club or group memberships, matchmaking, and/or other types of opportunities with screening questions that are relevant to the opportunities.

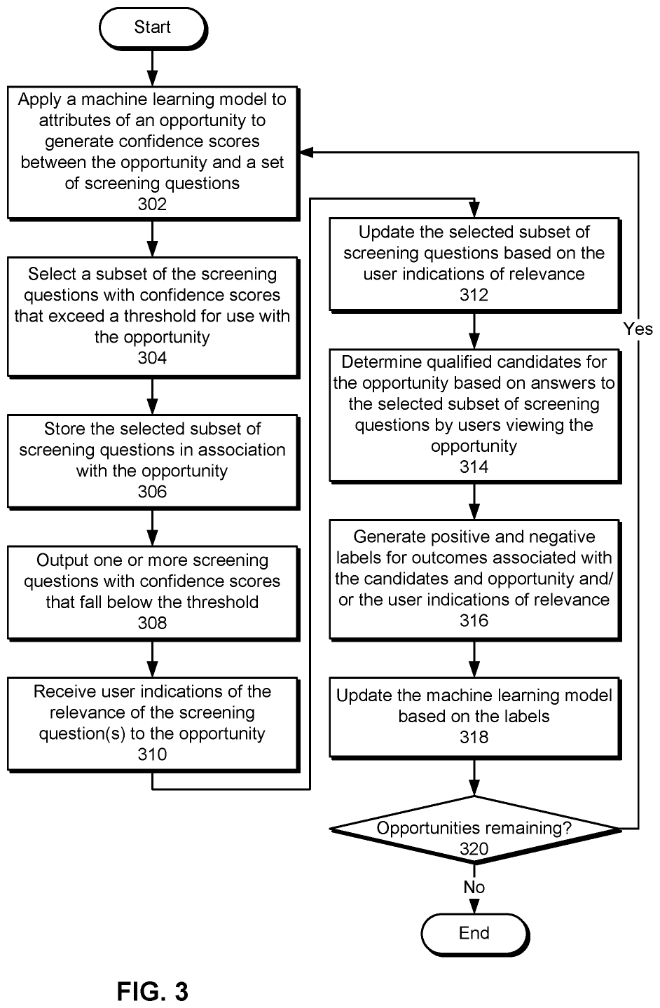

FIG. 3 shows a flowchart illustrating a process of performing screening-based opportunity enrichment in accordance with the disclosed embodiments. In one or more embodiments, one or more of the steps may be omitted, repeated, and/or performed in a different order. Accordingly, the specific arrangement of steps shown in FIG. 3 should not be construed as limiting the scope of the embodiments.

Initially, a machine learning model is applied to attributes of an opportunity to generate confidence scores between the opportunity and a set of screening questions (operation 302). For example, the attributes may include a standardized title, description, function, industry, seniority level, type of employment, set of skills, educational background, and/or other component of a job that is posted in an online system, such as online network 118 of FIG. 1. The attributes may be specified by a poster of the job and/or extracted from a text-based representation of the job. In turn, the machine learning model may output confidence scores between the job and a set of available screening questions for the jobs, with each confidence score representing the probability that a corresponding screening question matches the job's requirements or qualifications.

Next, a subset of the screening questions with confidence scores that exceed a threshold is selected for use with the opportunity (operation 304). For example, screening questions with confidence scores that exceed a percentile threshold, numeric threshold, and/or another type of threshold may be identified as having high likelihood of relevance to the opportunity.

In turn, the selected subset of screening questions is stored in association with the opportunity (operation 306). For example, one or more records of the opportunity may be updated with identifiers for and/or links to the selected screening questions. In turn, the screening questions may be retrieved and used to screen or filter candidates for the opportunity before the candidates are able to apply for the opportunity.

On the other hand, one or more screening questions may have confidence scores that fall below the threshold for high confidence, thus disqualifying such screening questions from being automatically added to and/or associated with the opportunity. Instead, these screening questions are outputted (operation 308), and user indications of the relevance of the screening question(s) to the opportunity are received (operation 310).

For example, one or more screening questions that fall below the threshold may be displayed with the content and/or attributes of the corresponding opportunity to a user. In turn, the user may verify the relevance or lack of relevance of each screening question to the opportunity, change one or more parameters of a screening question (e.g., the number of years of experience required to qualify for the opportunity) to increase the relevance of the screening question to the opportunity, specify a different screening question for the opportunity, and/or indicate that no available screening questions match the requirements or qualifications of the opportunity.

The selected subset of screening questions is updated based on the user indications of relevance (operation 312). For example, screening questions that are verified and/or specified by users to be relevant to the opportunity may be added to and/or associated with the opportunity.

In turn, qualified candidates for the opportunity are determined based on answers to the selected subset of screening questions by a set of candidates (operation 314). For example, the screening questions may be displayed to the candidates, and answers by the candidates to the screening questions may be used to filter the candidates and/or applications to the opportunity by the candidates.

Positive and negative labels are then generated for outcomes associated with the candidates and opportunity and/or the user indications of relevance (operation 316) associated with the screening questions. For example, positive labels may be generated for screening questions that are identified by users as relevant to the opportunity, profile views of candidates for the opportunity, messages from a moderator of the opportunity to candidates, scheduling of interviews of candidates for the opportunity, addition of candidates to a hiring pipeline for the opportunity, and/or hiring of a candidate for the opportunity. Negative labels may be generated for screening questions that are identified by users as not relevant to the opportunity, rejections of candidates for the opportunity, and/or a lack of action on candidates by a moderator for the opportunity.

Finally, the machine learning model is updated based on the labels (operation 318). For example, the machine learning model may be trained to better predict the labels based on attributes of the opportunity.

Operations 302-318 may be repeated for remaining opportunities (operation 320). For example, the machine learning model and/or user input may be used to select screening questions for jobs and/or opportunities that are posted in the online system (operations 302-312). The screening questions may then be used to determine candidates for the opportunity (operation 314) and generate labels that are used to update the machine learning model (operations 316-318). Consequently, new opportunities may be continually enriched with screening questions, and the machine learning model may be updated based on outcomes and/or labels associated with the opportunities and screening questions.

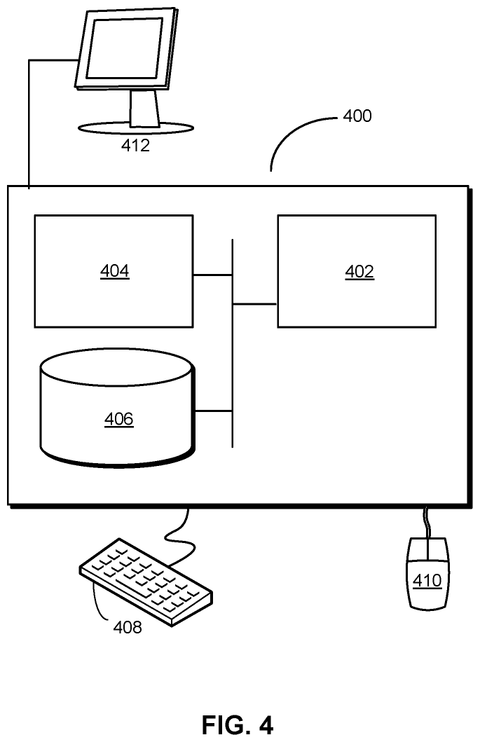

FIG. 4 shows a computer system 400 in accordance with the disclosed embodiments. Computer system 400 includes a processor 402, memory 404, storage 406, and/or other components found in electronic computing devices. Processor 402 may support parallel processing and/or multi-threaded operation with other processors in computer system 400. Computer system 400 may also include input/output (I/O) devices such as a keyboard 408, a mouse 410, and a display 412.

Computer system 400 may include functionality to execute various components of the present embodiments. In particular, computer system 400 may include an operating system (not shown) that coordinates the use of hardware and software resources on computer system 400, as well as one or more applications that perform specialized tasks for a user (e.g., a candidate and/or moderator for an opportunity). To perform tasks for the user, applications may obtain the use of hardware resources on computer system 400 from the operating system, as well as interact with the user through a hardware and/or software framework provided by the operating system.

In one or more embodiments, computer system 400 provides a system for processing data. The system includes a model-creation apparatus, a verification apparatus, and a management apparatus, one or more of which may alternatively be termed or implemented as a module, mechanism, or other type of system component. The management apparatus applies a machine learning model to attributes of an opportunity to generate a set of confidence scores between the opportunity and a set of screening questions. The management apparatus also selects a subset of the screening questions with confidence scores that exceed a threshold for use with the opportunity and stores the selected subset of the screening questions in association with the opportunity.

The verification apparatus outputs a screening question with a confidence score that falls below the threshold and receives, in response to the outputted screening question, a user indication of a relevance of the screening question to the opportunity. The verification apparatus then updates the selected subset of the screening questions based on the user indication of the relevance of the screening question to the opportunity.

The model-creation apparatus generates training data for the machine learning model based on the user indication of the relevance of the screening question to the opportunity, outcomes associated with candidates for the opportunity, and/or the attributes of the opportunity. The model-creation apparatus also updates the machine learning model based on the training data.

In addition, one or more components of computer system 400 may be remotely located and connected to the other components over a network. Portions of the present embodiments (e.g., verification apparatus, model-creation apparatus, management apparatus, data repository, model repository, online network, etc.) may also be located on different nodes of a distributed system that implements the embodiments. For example, the present embodiments may be implemented using a cloud computing system that enriches opportunities with screening questions that are presented to a set of remote members applying to the opportunities within or through an online network.

By configuring privacy controls or settings as they desire, members of a social network, a professional network, or other user community that may use or interact with embodiments described herein can control or restrict the information that is collected from them, the information that is provided to them, their interactions with such information and with other members, and/or how such information is used. Implementation of these embodiments is not intended to supersede or interfere with the members' privacy settings.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
applying, by one or more computer systems, a machine learning model to attributes of an opportunity to generate a set of confidence scores between the opportunity and a set of screening questions;
selecting, by the one or more computer systems, a subset of the screening questions with confidence scores that exceed a threshold for use with the opportunity; and
storing the selected subset of the screening questions in association with the opportunity.

2. The method of claim 1, further comprising:
outputting a screening question associated with a confidence score that falls below the threshold;
receiving, in response to the outputted screening question, a user indication of a relevance of the screening question to the opportunity; and
updating the selected subset of the screening questions based on the user indication of the relevance of the screening question to the opportunity.

3. The method of claim 2, further comprising:
generating training data for the machine learning model based on the user indication of the relevance of the screening question to the opportunity and the attributes of the opportunity; and
updating the machine learning model based on the training data.

4. The method of claim 2, wherein outputting the screening question comprises:
outputting the screening question with one or more corresponding attributes of the opportunity.

5. The method of claim 2, wherein the user indication of the relevance of the screening question to the opportunity comprises at least one of:
a confirmation of the relevance of the screening question to the opportunity;
an override of the screening question for the opportunity; and
a lack of a relevant screening question for the opportunity.

6. The method of claim 1, further comprising:
determining qualified candidates for the opportunity based on answers to the selected subset of the screening questions by a set of candidates;
generating positive labels and negative labels for outcomes associated with the set of candidates and the opportunity; and
updating the machine learning model based on the positive labels and the negative labels.

7. The method of claim 6, wherein generating the positive labels and the negative labels for the outcomes associated with the set of candidates and the opportunity comprises:
generating a positive label for an outcome comprising at least one of a profile view of a first candidate, a message from a moderator of the opportunity to a second candidate, scheduling of an interview of a third candidate, addition of a fourth candidate to a hiring pipeline, and hiring of a fifth candidate for the opportunity.

8. The method of claim 6, wherein generating the positive labels and the negative labels for the outcomes associated with the set of candidates and the opportunity comprises:
generating a negative label for an outcome comprising at least one of a rejection of a first candidate and a lack of action on a second candidate by a moderator of the opportunity.

9. The method of claim 1, further comprising:
mapping portions of a text-based representation of the opportunity to the attributes of the opportunity.

10. The method of claim 1, wherein the set of screening questions comprises at least one of:
a parameter; and
a condition associated with the parameter.

11. The method of claim 1, wherein the attributes of the opportunity comprise at least one of:
a title;
a description;
a function;
an industry;
a seniority level;
a type of employment;
a skill; and
an educational background.

12. The method of claim 1, wherein the set of screening questions is associated with at least one of:
work experience;
education;
location;
work authorization;
language;
visa status;
certifications;
expertise with tools; and
security clearances.

13. A system, comprising:
one or more processors; and
memory storing instructions that, when executed by the one or more processors, cause the system to:
apply a machine learning model to attributes of an opportunity to generate a set of confidence scores between the opportunity and a set of screening questions;
select a subset of the screening questions with confidence scores that exceed a threshold for use with the opportunity; and
store the selected subset of the screening questions in association with the opportunity.

14. The system of claim 13, wherein the memory further stores instructions that, when executed by the one or more processors, cause the system to:
output a screening question associated with a confidence score that falls below the threshold;
receive, in response to the outputted screening question, a user indication of a relevance of the screening question to the opportunity; and
update the selected subset of the screening questions based on the user indication of the relevance of the screening question to the opportunity.

15. The system of claim 14, wherein the memory further stores instructions that, when executed by the one or more processors, cause the system to:
generate training data for the machine learning model based on the user indication of the relevance of the screening question to the opportunity and the attributes of the opportunity; and
update the machine learning model based on the training data.

16. The system of claim 14, wherein the user indication of the relevance of the screening question to the opportunity comprises at least one of:
a confirmation of the relevance of the screening question to the opportunity;
an override of the screening question for the opportunity; and
a lack of a relevant screening question for the opportunity.

17. The system of claim 13, wherein the set of screening questions comprises at least one of:
a parameter; and
a condition associated with the parameter.

18. The system of claim 13, wherein the set of screening questions is associated with at least one of:
work experience;
education;
location;
work authorization;
language;
visa status;
certifications;
expertise with tools; and
security clearances.

19. A non-transitory computer-readable storage medium storing instructions that when executed by a computer cause the computer to perform a method, the method comprising:
applying a machine learning model to attributes of an opportunity to generate a set of confidence scores between the opportunity and a set of screening questions;
selecting a subset of the screening questions with confidence scores that exceed a threshold for use with the opportunity; and
storing the selected subset of the screening questions in association with the opportunity.

20. The non-transitory computer-readable storage medium of claim 19, the method further comprising:
outputting a screening question associated with a confidence score that falls below the threshold;
receiving, in response to the outputted screening question, a user indication of a relevance of the screening question to the opportunity; and
updating the selected subset of the screening questions based on the user indication of the relevance of the screening question to the opportunity.
